(19) United States
(12) Patent Application Publication
(10) Pub. No.: US 2008/0082372 A1
(43) Pub. Date: Apr. 3, 2008

(54) Driving simulator and method of evaluation of driver competency

(76) Inventor: Leon A. Burch, Prospect, CT (US)

Correspondence Address: EDWARDS ANGELL PALMER & DODGE LLP, P.O. BOX 55874, BOSTON, MA, 02205, US

(21) Appl. No.: 11/903,152

(22) Filed: Sep. 20, 2007

Related U.S. Application Data
(60) Provisional application No. 60/848,302, filed on Sep. 29, 2006.

(51) Int. Cl. G06Q 40/00

(52) U.S. Cl. 705/4

(57) ABSTRACT

A method determines insurability of drivers. The method includes simulating a driving experience for a driver in an interactive driving simulator. Performance of the driver in the simulated driving experience is evaluated to generate a driving proficiency score for the driver. The method also includes evaluating insurability of the driver based on the driving proficiency score. A system also determines insurability of drivers.

### CROSS-REFERENCE TO RELATED APPLICATIONS

This application claims benefit of priority to U.S. Provisional Application Ser. No. 60/848,302, filed Sep. 29, 2006, which is incorporated herein by reference in its entirety.

### BACKGROUND OF THE INVENTION

1. Field of the Invention

The subject invention relates to a method of evaluating driver ability using realistic driving simulators, and more particularly to linking insurance incentives to driver performance in interactive driving simulators.

2. Description of Related Art

Driving simulators for training and recreation are well known. It is also well known to simulate the sights, sounds, and feeling of motion in simulators for aircraft, automobiles, and other vehicles. One such driving simulator is shown in U.S. Pat. No. 6,431,872 to Shiraishi et al., entitled “Drive Simulation Apparatus,” which is incorporated herein by reference in its entirety. Recent advances in simulator technology have made simulated driving experiences more and more authentic.

Recent technological advances have also made automobiles safer. Crush-proof zones, airbags, and seat belts have successfully saved lives in automobile accidents. However, the number of accidents and the cost of those accidents have not necessarily decreased as a result of these advances. Moreover, it is known for insurance providers to create incentives for safe driving through pricing of premiums, and/or to penalize drivers for having accidents, traffic violations, and other indications of unsafe driving. In some circumstances, an insurance provider may determine that a particular driver is not insurable. However, there is a limited predictive aspect to these incentives since they rely on hindsight of a driver's performance to predict safety and determine incentives going forward. This limitation to hindsight is particularly apparent when dealing with new drivers who do not have any driving record upon which to base predictions. It is also possible that a driver with a well-established history may experience a change in circumstances that renders the driving record less predictive or even misleading.

Such conventional methods and systems have generally been considered satisfactory for their intended purpose. However, there still remains a continued need in the art for a system and method for determining insurability of drivers that is more predictive. There also remains a need for a system and method for determining insurability of drivers that is easy and inexpensive to make and use. The present invention provides a solution for these problems.

### SUMMARY OF THE INVENTION

The purpose and advantages of the present invention will be set forth in and become apparent from the description that follows. Additional advantages of the invention will be realized and attained by the methods and systems particularly pointed out in the written description and claims hereof, as well as from the appended drawings.

To achieve these and other advantages and in accordance with the purpose of the invention, as embodied herein, the invention includes a method of determining insurability for drivers. The method includes simulating a driving experience for a driver in an interactive driving simulator, evaluating performance of the driver in the simulated driving experience to generate a driving proficiency score for the driver, and evaluating insurability of the driver based on the driving proficiency score.

In accordance with another aspect of the invention, the step of evaluating insurability of the driver includes evaluating whether or not the driver is eligible for insurance coverage. It is also contemplated that the step of evaluating insurability of the driver can include determining insurance premiums. Moreover, the step of evaluating insurability of the driver can also include comparing the driving proficiency score with historical driver data.

The steps of simulating a driving experience for a driver, evaluating performance of the driver, and evaluating insurability of the driver can be periodically repeated. These steps can be repeated annually, biannually, or on any other suitable time period. In a preferred embodiment, the method includes the step of appending a historical record with the driving proficiency score. In a another preferred embodiment, the method includes the step of appending a historical statistical record with information on performance of the driver in real world situations and associating the information with the driving proficiency score for use in determining insurability of other drivers based on their respective driving proficiency score.

It is also contemplated that the step of simulating can include simulating a variety of driving conditions including at least one of night time driving, wet pavement, fog, limited visibility, city conditions, highway conditions, mechanical failure, specialized terrain, mountainous terrain, torrential rain, flooding, ice, snow, wind, and cross wind. Moreover, the step of simulating can include simulating specialized driving equipment including at least one of forklifts, specialized trucks, semi-tractor trailer trucks, tank trucks, busses, school busses, conventional discharge concrete trucks, front discharge concrete trucks, dump trucks, special use vehicles, ready-mix trucks, recreational vehicles, and motorcycles.

The invention also provides a system for determining insurability of drivers. The system includes a driving simulator configured and adapted to simulate driving situations and to output performance data based on performance of a driver in the simulated driving situations. The system also includes means for evaluating insurability of the driver, the means for evaluating being operably connected to receive the performance data from the driving simulator for use in evaluating insurability of the driver.

In accordance with another aspect of the invention, the means for evaluating insurability is configured and adapted to determine whether or not a driver is eligible for insurance coverage. In a preferred embodiment, the means for evaluating insurability is configured and adapted to determine insurance premiums for a driver.

In another preferred embodiment, the system further includes a database containing historical data of driving performance. The database is operatively connected to the means of evaluating insurability, which is configured and adapted to evaluate insurability of the driver based on comparison of the performance data of the driver to the historical data. The database can be configured and adapted to append the historical data with the performance data of the driver. It is also contemplated that the system can further include means for accepting real-world performance data for the driver and for appending the historical data to include the real-world performance data, wherein the means for evaluating insurability is configured and adapted to account for the real-world performance data in evaluating insurability of the driver.

The driving simulator can include means for simulating a variety of driving conditions including at least one of night time driving, wet pavement, fog, limited visibility, city conditions, highway conditions, mechanical failure, specialized terrain, mountainous terrain, torrential rain, flooding, ice, snow, wind, and cross wind. It is also possible for the driving simulator to include means for simulating specialized driving equipment including at least one of forklifts, specialized trucks, semi-tractor trailer trucks, tank trucks, busses, school busses, conventional discharge concrete trucks, front discharge concrete trucks, dump trucks, special use vehicles, ready-mix trucks, recreational vehicles, and motorcycles.

The invention also includes a machine readable medium containing program instructions for controlling a processor to determine insurability of drivers. The program includes a code segment for instructing a processor to accept a score of driver proficiency as an input. The score of driver proficiency is a product of evaluating performance of a driver in an interactive driving simulation. The program further includes a code segment for instructing the processor to calculate insurability of the driver based on the score of driver proficiency and a code segment for instructing the processor to output information on the insurability of the driver.

In a preferred embodiment, the code segment for instructing the processor to calculate insurability of the driver includes instructions for calculating insurance premiums for the driver, and the code segment for instructing the processor to output information includes instructions for outputting the insurance premiums. It is also contemplated that the program can further include a code segment for instructing the processor to retrieve data from a database of historical data, wherein the code segment for instructing the processor to calculate insurability of the driver includes instructions to account for the historical data.

It is to be understood that both the foregoing general description and the following detailed description are exemplary and are intended to provide further explanation of the invention claimed. The accompanying drawing, which is incorporated in and constitutes part of this specification, is included to illustrate and provide a further understanding of the method and system of the invention. Together with the description, the drawing serves to explain the principles of the invention.

### BRIEF DESCRIPTION OF THE DRAWINGS

FIG. 1 is a schematic view of a first representative embodiment of a system for determining insurability of drivers in accordance with the present invention, showing the driving simulator, means for evaluating a driver, database, and means for inputting and outputting.

### DETAILED DESCRIPTION OF THE PREFERRED EMBODIMENT

Reference will now be made in detail to the present preferred embodiments of the invention, examples of which are illustrated in the accompanying drawings. The method and corresponding steps of the invention will be described in conjunction with the detailed description of the system.

The devices and methods presented herein may be used for determining insurability of drivers. The present invention is also well suited for decreasing the number driving accidents as well as decreasing the severity of driving accidents. The subject invention is also directed to a new and useful method of linking the use of driving simulators to insurance rates. Moreover, the present invention relates generally to a method of using simulators in driver education and linking the use of the simulators with insurance rates.

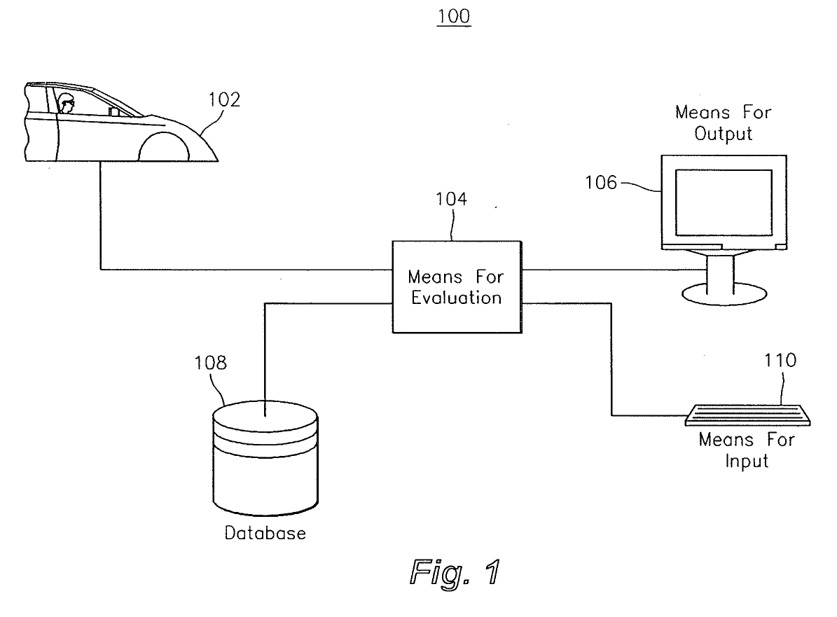

FIG. 1 shows a schematic view of a system, generally designated 100, for determining insurability of drivers. System 100 can also be used in conjunction with a method of determining insurability of drivers, in accordance with the invention. The method includes simulating a driving experience for a driver in an interactive driving simulator, evaluating performance of the driver in the simulated driving experience to generate a driving proficiency score for the driver, and evaluating insurability of the driver based on the driving proficiency score.

For purposes of illustration and not limitation, as embodied herein and as depicted in FIG. 1, the method includes using a driving simulator 102, which can be like the simulator disclosed in U.S. Pat. No. 6,431,872, in driver education. Preferably, the simulator 102 is capable of a maximal level of realism to make the simulation experience authentic. Authenticity helps new drivers prepare for real world driving. It also allows for more accurate predictions of how students of all levels of experience will perform in the real world. Simulator 102 functionality can include means full simulation of motion, including full turn-over and other movements, actions, and sensations, as is known in the art. Also, it is preferable that simulator 102 employ realistic sounds and high quality video images as is known in the art of simulating automobiles, aircraft, and spacecraft.

Simulator 102 can involve a variety of situations for testing drivers' abilities to minimize accidents and follow the rules of the road. It is further contemplated that simulator 102 can be configured to test driving ability in a variety of driving conditions such as, by way of example and not limitation, night time driving, wet pavement, fog and limited visibility driving, city conditions, highway driving, equipment failure, and specialized terrain such as mountainous terrain. Also, simulator 102 is preferably configured for simulating driving situations in a full range of whether conditions including but not limited to torrential rain, flooding, ice, snow, wind, and cross wind. Those skilled in the art will readily appreciate that any suitable conditions can be simulated without departing from the spirit and scope of the invention.

In further accordance with the invention, the method includes evaluating driver performance on the simulation system. Means for evaluating 104 can include an objective system of evaluating drivers rather than more traditional subjective evaluation systems. This can involve generating a score based on various criteria including conformance to the rules of the road, accident avoidance, and other suitable performance criteria based on performance in simulator 102.

In further accordance with the method of the invention, the method includes determining insurability for drivers based on their performance in simulated driving experiences. By way of example, and not limitation, evaluation means 104 can use the score generated when evaluating driver performance to determine whether or not a driver is eligible for an insurance policy. It is also possible to use the score of driver performance to determine premiums for a given insurance policy. For example, discounts in auto insurance could be offered to drivers who pass a threshold score.

This determination can include correlating a driver's performance in simulator 102 with historical data of simulator-trained drivers to predict the driver's potential real world performance to determine eligibility for an insurance policy or to determine premiums. Database 108 can be used to correlate historical data with data on a particular driver during the evaluation process. Those skilled in the art will readily appreciate that database 108 can be appended with the driver's performance data, as well as data on the driver's real-world performance (such as a driving record, demographic data, or other suitable data) for use in evaluating future drivers with system 100.

System 100 can include means for input, such as keyboard 110, optical or magnetic drives, network connections, or any other suitable input means known in the art for the purposes of entering data such as driver information and records. System 100 also includes means for providing output 106 for presenting results of the driver evaluation, which can be a screen, printer, network connection, or any other suitable output device known in the art.

By way of example and not limitation, it is also contemplated that discounted insurance rates can be offered to graduates of driver education programs utilizing driver simulators, based on their performance in the simulator. It is further contemplated that system 100 can be used to evaluate specialized and commercial drivers. System 100 can be configured to include simulation and evaluation of drivers for forklifts, specialized trucks, semi-tractor trailer trucks, tank trucks, busses, school busses, concrete trucks (conventional and front discharge), dump trucks, special use vehicles, ready-mix trucks, recreational vehicles, motorcycles, and other similar equipment. Those skilled in the art will readily appreciate that any suitable type of vehicle can be simulated for evaluating insurability of drivers without departing from the spirit and scope of the invention.

The method and system can be used in conjunction with driver education programs, or simply as a test for evaluation of drivers. Those skilled in the art will appreciate that drivers trained in simulators will likely be better equipped than the untrained population in making decisions and employing practices that avoid or minimize automobile accidents.

The method can optionally include a requirement for periodic re-certification to maintain an insurance policy, assuming an acceptably safe driving record is maintained. It is also contemplated that the method can include re-certification to maintain the discounted insurance rates. In accordance with the invention, graduates of driver education programs who have received discounted rates because of their use of driving simulators can be periodically required to submit to further evaluation in a driver simulator. By way of example, and not limitation, commercial drivers may be required to recertify in a driving simulator every two years, non-commercial drivers may be required to recertify every four years, and drivers over age 65 may be required to recertify every two years. It is also contemplated that drivers can be evaluated annually, or biannually for purposes of complying with federal Department of Transportation standards or regulations, for example. Those skilled in the art will readily appreciate that any suitable period can be used without departing from the spirit and scope of the invention.

The accumulation of historical data, correlation between simulator performance and historical data, the discounting of insurance rates based on simulator performance, and other systems of the invention can be carried out on one or more computers with or without graphical interface, as is known in the art. The methods of the invention can also be carried out by conventional non-computer means without departing from the scope of the invention.

This method will allow insurance companies to achieve an insured customer base composed of drivers of very specific driver proficiency and safety records. This will facilitate historical data analysis and those skilled in the art will also appreciate how to apply the system and method into other marketing programs and applications without departing from the spirit and scope of the invention. The method provides a way of decreasing the number of automobile accident claims and lowering the amount lost per claim.

The invention also provides a machine readable medium containing program instructions for controlling a processor to determine insurability of drivers. The program includes a code segment for instructing a processor to accept a score of driver proficiency as input. The score of driver proficiency is a product of evaluating performance of a driver in an interactive driving simulation. A code segment is provided for instructing the processor to calculate insurability of the driver based on the score of driver proficiency. A code segment is included for instructing the processor to output information on the insurability of the driver.

By way of example and not limitation, a machine readable medium containing program instructions can be used in conjunction with a computer. A code segment can instruct evaluation means 104 to accept a score of driver proficiency generated using a simulator (e.g. 102), which can be connected to or separate from the computer. The score of driver proficiency reflects performance of a driver in an interactive simulation experience, as described above. A code segment instructs the processor to calculate insurability of the driver based on this score. Another code segment instructs the processor to output information on the resulting calculations. This can involve calculating and outputting (e.g. on screen 106 or a printer) insurance premiums. Moreover, the program can include a code segment for retrieving data from a database (e.g. 108) with historical data for use in calculating insurability.

The functions of the various elements of the invention may be provided through the use of dedicated hardware as well as hardware capable of executing software in association with appropriate software. When provided by a processor, the functions may be provided by a single dedicated processor, by a single shared processor, or by a plurality of individual processors, some of which may be shared. The functions of those various elements may be implemented by, for example, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the description herein any element described for performing a specified function, or method for performing a function is intended to encompass any way of performing that function including, for example, a) a combination of circuit elements which performs that function or b) software in any form, including, therefore, firmware, microcode or the like, combined with appropriate circuitry for executing that software to perform the function. The invention as described by the foregoing description resides in the fact that the functionalities provided by the various recited means are combined and brought together in the manner described. Applicant thus regards any means that can provide those functionalities as equivalent to those described herein.

Similarly, it will be appreciated that the system flows described herein represent various processes that may be substantially represented in computer-readable medium and so executed by a computer or processor, whether or not such computer or processor is explicitly described. Moreover, the various processes can be understood as representing not only processing and/or other functions but, alternatively, as blocks of program code that carry out such processing or functions.

The methods and systems of the present invention, as described above, provide for a method, system, machine readable program and graphical user interface with superior functionality that can facilitate pricing of insurance rates and premiums, decrease the number of vehicular accidents, and minimize the damages from vehicular accidents. The invention is also aimed at reducing the severity of automobile accidents. It will be apparent to those skilled in the art that various modifications and variations can be made in the embodiments of the present invention without departing from the spirit or scope of the invention. Thus, it is intended that the present invention include modifications and variations that are within the scope of the foregoing description and their equivalents.

What is claimed is:

1. A method of determining insurability for drivers, the method comprising:
a) simulating a driving experience for a driver in an interactive driving simulator;
b) evaluating performance of the driver in the simulated driving experience to generate a driving proficiency score for the driver; and
c) evaluating insurability of the driver based on the driving proficiency score.

2. A method of determining insurability of drivers as recited in claim 1, wherein the step of evaluating insurability of the driver includes evaluating whether or not the driver is eligible for insurance coverage.

3. A method of determining insurability of drivers as recited in claim 1, wherein the step of evaluating insurability of the driver includes determining insurance premiums.

4. A method of determining insurability of drivers as recited in claim 1, wherein the step of evaluating insurability of the driver includes comparing the driving proficiency score with historical driver data.

5. A method of determining insurability of drivers as recited in claim 1, wherein the steps of simulating a driving experience for a driver, evaluating performance of the driver, and determining insurability of the driver are periodically repeated.

6. A method of determining insurability of drivers as recited in claim 5, wherein the steps of simulating a driving experience for a driver, evaluating performance of the driver, and determining insurability of the driver are repeated on an annual basis.

7. A method of determining insurability of drivers as recited in claim 5, wherein, the steps of simulating a driving experience for a driver, evaluating performance of the driver, and determining insurability of the driver are repeated on an biannual basis.

8. A method of determining insurability as recited in claim 1, further comprising the step of appending a historical record with the driving proficiency score.

9. A method of determining insurability as recited in claim 8, further comprising the step of appending a historical statistical record with information on performance of the driver in real world situations and associating the information with the driving proficiency score for use in determining insurability of other drivers based on their respective driving proficiency score.

10. A method of determining insurability of drivers as recited in claim 1, wherein the step of simulating includes simulating a variety of driving conditions including at least one of night time driving, wet pavement, fog, limited visibility, city conditions, highway conditions, mechanical failure, specialized terrain, mountainous terrain, torrential rain, flooding, ice, snow, wind, and cross wind.

11. A method of determining insurability of drivers as recited in claim 1, wherein the step of simulating includes simulating specialized driving equipment including at least one of forklifts, specialized trucks, semi-tractor trailer trucks, tank trucks, busses, school busses, conventional discharge concrete trucks, front discharge concrete trucks, dump trucks, special use vehicles, ready-mix trucks, recreational vehicles, and motorcycles.

12. A system for determining insurability of drivers, the system comprising:
a) a driving simulator configured and adapted to simulate driving situations and to output performance data based on performance of a driver in the simulated driving situations; and
b) means for evaluating insurability of the driver, the means for evaluating being operably connected to receive the performance data from the driving simulator for use in evaluating insurability of the driver.

13. A system for determining insurability of drivers as recited in claim 12, wherein the means for evaluating insurability is configured and adapted to determine whether or not a driver is eligible for insurance coverage.

14. A system for determining insurability of drivers as recited in claim 12, wherein the means for evaluating insurability is configured and adapted to determine insurance premiums for a driver.

15. A system for determining insurability of drivers as recited in claim 12, further comprising a database containing historical data of driving performance, the database being operatively connected to the means for evaluating insurability, wherein the means for evaluating insurability is configured and adapted to evaluate insurability of the driver based on comparison of the performance data of the driver to the historical data.

16. A system for determining insurability of drivers as recited in claim 15, wherein the database is configured and adapted to append the historical data with the performance data of the driver.

17. A system for determining insurability of drivers as recited in claim 16, further comprising means for accepting real-world performance data for the driver and for appending the historical data to include the real-world performance data, wherein the means for evaluating insurability is configured and adapted to account for the real-world performance data in determining insurability of the driver.

18. A system for determining insurability of drivers as recited in claim 12, wherein the driving simulator includes means for simulating a variety of driving conditions including at least one of night time driving, wet pavement, fog, limited visibility, city conditions, highway conditions, mechanical failure, specialized terrain, mountainous terrain, torrential rain, flooding, ice, snow, wind, and cross wind.

19. A system for determining insurability of drivers as recited in claim 12, wherein the driving simulator includes means for simulating specialized driving equipment including at least one of forklifts, specialized trucks, semi-tractor trailer trucks, tank trucks, busses, school busses, conventional discharge concrete trucks, front discharge concrete trucks, dump trucks, special use vehicles, ready-mix trucks, recreational vehicles, and motorcycles.

20. A machine readable medium containing program instructions for controlling a processor to determine insurability of drivers, the program comprising:
a) a code segment for instructing a processor to accept a score of driver proficiency as an input, wherein the score of driver proficiency is a product of evaluating performance of a driver in an interactive driving simulation;
b) a code segment for instructing the processor to calculate insurability of the driver based on the score of driver proficiency; and
c) a code segment for instructing the processor to output information on the insurability of the driver.

21. A machine readable medium as recited in claim 20, wherein the code segment for instructing the processor to calculate insurability of the driver includes instructions for calculating insurance premiums for the driver, and wherein the code segment for instructing the processor to output information includes instructions for outputting the insurance premiums.

22. A machine readable medium as recited in claim 20, further comprising a code segment for instructing the processor to retrieve data from a database of historical data, and wherein the code segment for instructing the processor to calculate insurability of the driver includes instructions to account for the historical data.
